(19) United States
(12) Patent Application Publication
(10) Pub. No.: US 2010/0293040 A1
(43) Pub. Date: Nov. 18, 2010

(54) Technical task performance techniques

(75) Inventors: Alpheus Bingham, JR., Carmel, IN (US); Aaron Leigh Schacht, Zionsville, IN (US)

Correspondence Address: MINTZ LEVIN COHN FERRIS GLOVSKY & POPEO, ONE FINANCIAL CENTER, BOSTON, MA, 02111, US

(73) Assignee: InnoCentive, Inc., Waltham, MA (US)

(21) Appl. No.: 12/660,690

(22) Filed: Mar. 1, 2010

Related U.S. Application Data
(63) Continuation of application No. 10/415,760, filed on Sep. 29, 2003, now abandoned.
(60) Provisional application No. 60/249,980, filed on Nov. 20, 2000.

(51) Int. Cl. G06Q 10/00

(52) U.S. Cl. 705/11

(57) ABSTRACT

One form of the present invention includes a computer network, an input device, and a computer server. The computer server is coupled to the network and input device, and is programmed to present a publicly accessible description over the network. This description includes a reward offer contingent on acceptable development of a technical task. The computer server is responsive to input from the input device to alter the description when it is determined that the task has been acceptably performed. In a further form, the task involves production of a chemical compound sample and chemical analysis equipment is included to evaluate the sample.

### BACKGROUND

The present invention relates to the performance of technical tasks, and more particularly but not exclusively, relates to strategies to more effectively perform tasks in the area of pharmaceutical development.

The process of providing a new drug includes many steps that may involve substantial amounts of time, resources, and expenses. In its earliest stages, this process typically includes the discovery of a molecule with one or more potentially beneficial therapeutic indications. Following discovery, laboratory testing of the potential drug is usually conducted to determine suitability as a candidate for formal regulatory approval. Formal requirements for drug approval typically include verifying synthesis routes for producing the new drug, conducting clinical trials with the drug to establish safety and efficiency, making regulatory submissions, and finally preparing the drug for market. Each of these steps requires specific expertise, and the time and expense involved can be great. Development of drugs can therefore be a very expensive, high-risk business.

From a business perspective, the success of a potential drug often depends on the identification of an economic route to synthesize it. Also, a successful outcome is frequently enhanced by developing or refining several other corresponding technical tasks, such as pharmacological assays, formulations, and the like. The rapid and efficient development of such tasks presents an ever-growing challenge as the desire to more rapidly bring new drugs to market increases.

On occasion, drug developers will seek an outside consultant or developer having specific expertise in regard to a selected task. The business arrangement with the outside source is typically through a service and/or supply contract, partnership, or joint venture agreement. Indeed, various tasks may be outsourced to a number of different outside sources in this manner. Moreover, in an attempt to more rapidly develop a given task, a drug company might pay multiple independent parties to work towards the development of the same task. Ultimately, distributing developmental tasks in this manner would lead to the development and marketing of drugs that otherwise may not have been possible due to limited technical expertise or limited resources of a given company. Indeed, this kind of task distribution can be beneficial to developments in many other areas of technology, such as the material sciences, electronics, or optics, to name just a few.

Unfortunately, the ability to increase the number of independent parties working on a given task or development is limited by the costs of such an endeavor. Thus, needs remain for techniques to enhance the performance of technical tasks by involving multiple parties in a unique way. The present invention involves methods and systems that satisfy these needs by providing a contingent reward or “bounty” to motivate acceptable technical task performance.

### SUMMARY OF THE INVENTION

One embodiment of the present invention includes a unique technical task performance technique. Other embodiments include unique systems and methods directed to the performance of technical tasks.

Another embodiment of the present invention includes providing a description of a technical task to a number of parties and offering a bounty to any party that performs the task in accordance with certain requirements. Performance by at least one of the parties is evaluated and the bounty is awarded to one of the parties that performs the task in compliance with the requirements.

A further embodiment of the present invention includes providing an offer to reward any of several parties for development of an acceptable chemical synthesis procedure. A submission is evaluated that relates to a procedure developed in response to this offer for each of a number of the parties. One of the parties is determined to have developed the acceptable synthesis procedure and is rewarded. In one form, this procedure is directed to the more economical synthesis of a drug chemical.

Yet a further embodiment of the present invention includes publishing a description with a reward offer for acceptable development of a technical task for a chemical compound and providing an amount of the chemical compound to each of a number of parties responsive to the offer. Performance of the technical task by at least one of the parties is evaluated and one of the parties is rewarded in accordance with the offer.

Still a further embodiment of the present invention includes publishing a description of a technical task to a number of parties. The description offers a reward contingent upon the performance of the technical task by any of the parties in accordance with a predefined requirement. One of the parties is determined to perform the task in accordance with the predefined requirement and the reward is provided to that party. The publication can take place over a publicly accessible computer network, such as the internet. Further, the technical task can be directed to technical research, laboratory testing, product discovery, product development, and/or product manufacture, just to name a few.

Accordingly, one object of the present invention is to provide a unique technical task performance technique.

Another object is to provide a unique system or method directed to technical task performance.

Further objects, embodiments, forms, advantages, benefits, features, and aspects of the present invention shall become apparent from the description and drawings contained herein.

### BRIEF DESCRIPTION OF DRAWINGS

FIG. 1 is a diagrammatic view of a system of one embodiment of the present invention.

FIGS. 2A and 2B collectively depict a flowchart of one routine for operating the system of FIG. 1.

FIG. 3 is an example of a technical task description presented in accordance with the routine of FIGS. 2A and 2B.

### DESCRIPTION OF PREFERRED EMBODIMENTS

While the present invention may be embodied in many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

One embodiment of the present invention is a method to motivate technical task performance by offering a reward contingent on development of the process in accordance with one or more acceptance criteria. This method is especially significant in the area of drug development tasks such as synthesis procedures, assays, formulations, and the like. In another embodiment, a method includes providing a description including a reward offer for acceptable performance of a technical task involving a chemical compound, and providing an amount of the chemical compound to each of several parties responsive to the reward offer. Such methods provide an incentive for a greater number of parties to perform specified technical tasks than can ordinarily be economically justified using existing schemes. Further, this strategy has the potential to result in a more diverse array of technical task performance approaches than existing schemes; and thereby enrich the number of options from which to choose.

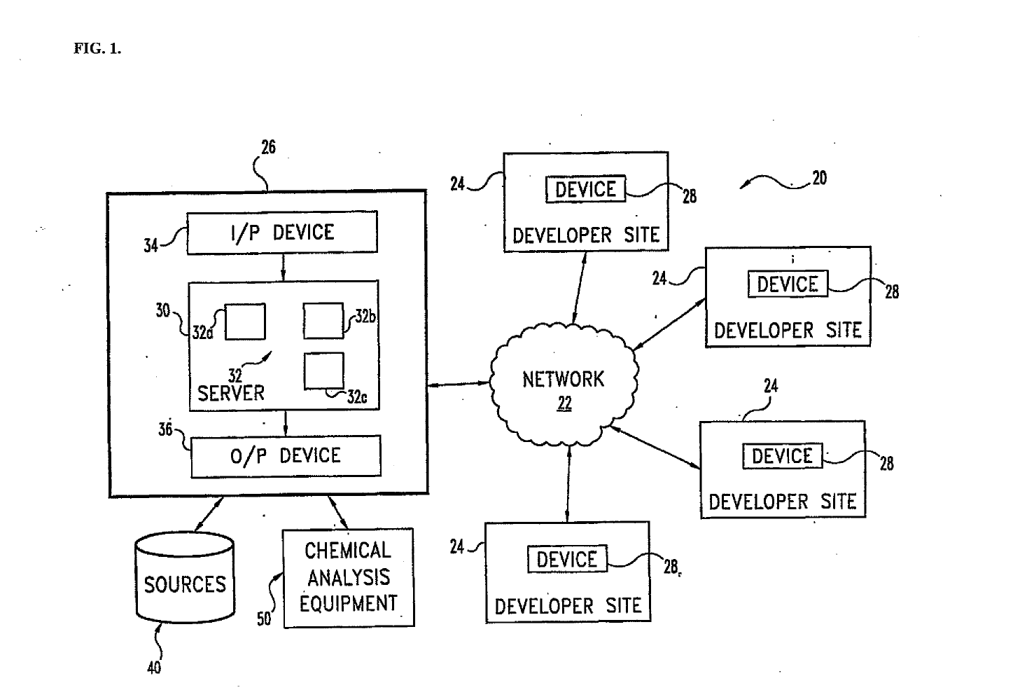

Still other embodiments include systems to implement such methods. For example, FIG. 1 illustrates system 20 of one embodiment of the present invention. System 20 includes computer network 22 that preferably includes a publicly accessible, Wide Area Network (WAN), such as the Internet. Computer network 22 communicatively links a number of potential developer sites or parties 24 and bounty offering/posting site 26. Developer sites 24 each represent one or more companies, universities, individuals, or other entities that might have an interest in performing one or more technical tasks or services. While four developer sites 24 are illustrated, for the sake of clarity it should be understood that more or fewer development sites 24 could be coupled to computer network 22 in the manner illustrated. Typically, many more prospective developer sites 24 would be coupled to computer network 22 for an embodiment of the present invention that includes the Internet. Developer sites 24 each include one or more computers or other interface devices 28 to communicate over computer network 22.

Offering/posting site 26 includes at least one computer server 30 for publishing one or more descriptions 32 that each relate to a technical task, a few of which are schematically represented in FIG. 1 as descriptions 32a, 32b, and 32c. Offering/posting site 26 further includes an input (I/P) device 34 and an output (O/P) device 36 each operatively coupled to server 30. Input device 34 may be a mouse, keyboard, trackball, voice recognition arrangement, a combination of these, or a different configuration as would occur those skilled in the art for receiving input from a server operator. Output device 36 can include a visual display, aural output arrangement, a printer, a combination of these, or a different configuration as would occur to those skilled in the art to provide output from server 30 to the server operator.

Offering/posting site 26 also has access to one or more sources 40 of chemical compounds that are schematically represented in FIG. 1. These chemical compounds are involved in the pharmaceutical development(s) to which one or more of the technical task descriptions 32 are directed. FIG. 1 also schematically depicts chemical analysis equipment 50 such as a mass spectrometer, nuclear magnetic resonance spectrometer, infra-red spectrometer, ultra-violet spectrometer, gas chromatograph device, and/or one or more other chemical analysis devices that can be used to evaluate various chemically related technical tasks. Any of developer sites 24 may likewise include such equipment, but are not shown as such to preserve clarity.

For a form of computer network 22 including the Internet, server 30 is preferably configured to provide a website upon which descriptions 32 are each posted as one or more web pages that can be accessed using a standard web browser program. For instance, devices 28 of sites 24 could be used in conjunction with a web browser to access this form of descriptions 32. For web- and nonweb-based forms of the present invention, descriptions 32 can be made available to public in a totally unrestricted manner or restricted in part or in whole to selected individuals or groups by requiring entry of a password, decryption key, or the like. In another form of the present invention, access can be conditioned on acceptance of a confidentiality agreement by the inquiring party. Alternatively or additionally, descriptions 32 can be provided using a different media selected to reach potential process developers. Indeed, in one alternative embodiment, a computer network is not utilized.

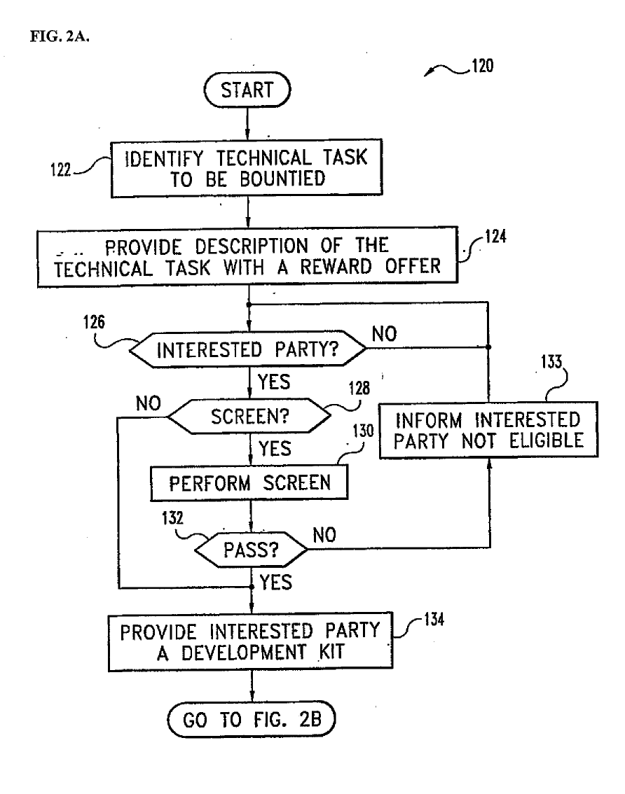

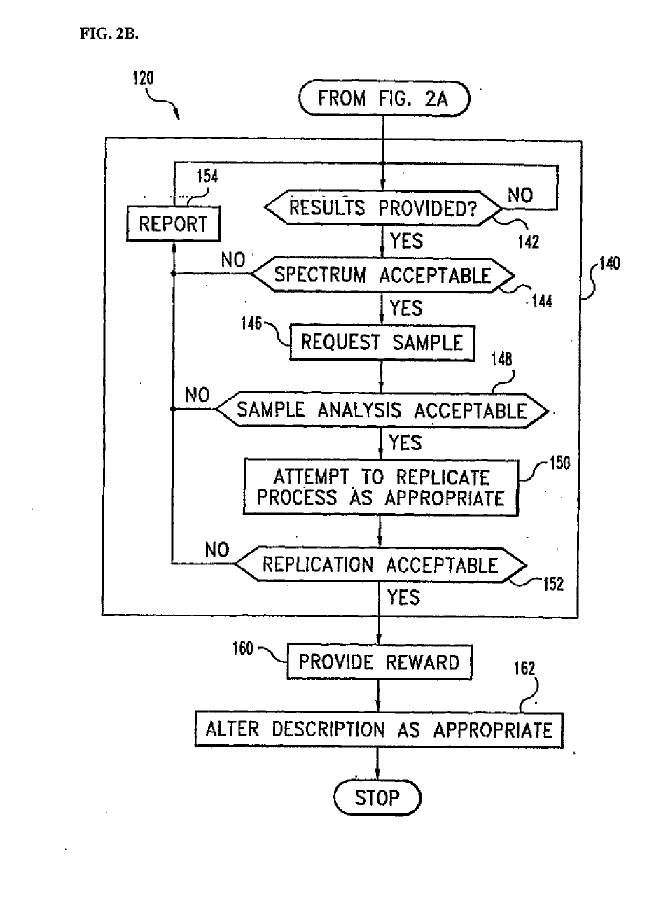

FIGS. 2A and 2B depict system routine 120 in flowchart form. Referring specifically to FIG. 2A, routine 120 begins in stage 122 with the identification of a technical task for which it is suitable to offer a reward contingent on meeting predetermined acceptance requirement(s). In the case of a drug chemical application, various so-called “wet lab” tasks might include providing: (a) a more economical procedure to synthesize the target drug chemical and/or an intermediate chemical compound; (b) one or more samples of new chemical structures for pharmacological testing; (c) an analysis procedure for assaying a new substance; (d) a formulation of a new molecule entity as a new potential drug product; (e) a procedure for constructing a new chemical library; (f) a toxicity study of a new potential drug substance; (g) an identification of one or more metabolites; (h) one more pharmacological screens to show drug activity; (i) one or more surrogate markets for a disease state (lab test to predict clinical results); (j) an animal model for a disease; and/or (k) a clinical or blood plasma assay of a drug under test, just to name a few.

In addition or as an alternative to these wet lab examples, other laboratory-oriented technical tasks might include providing: (a) a new way of integrating/connecting laboratory equipment; (b) a new toxicology prediction procedure; (c) a statistical optimization protocol for one or more laboratory experiments; and/or (d) a drug efficacy prediction tool/procedure for Structure-Activity Relationships (SARs).

Next, a task description, such as one of descriptions 32, is published in stage 124 by site 26 using server 30. Description 32 preferably states the reward offer as a fixed monetary amount, a monetary amount that varies with indicated performance criteria, a portion of production sales, a combination of these, or in a different manner as would occur to those skilled in the art. Alternatively or additionally, an invitation to bid on the reward terms could be presented in description 32. Description 32 can also set-forth the requirement or requirements from which to determine entitlement to the reward. Description 32 is made available via computer network 22 as one or more web pages. In other embodiments, description 32 can be alternatively or additionally provided by video, telefax, hard copy, verbal form, and/or with a different communication technique known to those skilled in the art besides a computer network.

After stage 124, conditional 126 is encountered that tests whether there is a party interested in description 32 as indicated by an email inquiry, or other form of communication. Such communication could be from any prospective developer site 24 via the corresponding device 28, by telephone, telefax, or through different communication techniques as are known to those skilled in the art. If the test of conditional 126 is negative, route 120 loops back to conditional 126 until the test is affirmative. Once conditional 126 is affirmative, conditional 128 is encountered to test whether the interested party should be screened to determine suitability as a provider of the subject technical task. If a screen is applied, the affirmative branch of conditional 128 leads to stage 130 to perform the associated screening. Next, conditional 132 tests if screen 130 is passed by the interested party. If not, the interested party is informed of their ineligibility to participate in stage 133, and routine 120 again loops back to conditional 126.

The screening process of routine 120 can be directed to any number of different criteria before an acceptable party can become a participant. For example, this screening criteria may include verification that certain equipment and/or resources are available to the interested party. Optionally, credentials of the interested party can be investigated through stage 130. Screening stage 130 can be used to conduct a procedure to qualify the interested party for continued participation. Alternatively or additionally, stage 130 can include establishment of a confidentiality agreement between the interested party and the entity represented by site 26 to keep later revealed details confidential. In other embodiments, the screening provided by conditionals 128 and 132, and stages 130 and 133 can be optional or absent.

If conditional 128 is negative (no screen) or the conditional 132 is affirmative (screening of stage 130 is passed), then routine 120 proceeds to stage 134. In stage 134, the interested party is provided a corresponding development kit that can include more detailed descriptive information, and/or a sample amount of one or more materials to which the corresponding technical task is directed. In the case of a pharmaceutical development application, a sample of a drug chemical associated with the development could be provided. In alternative embodiments, the provision of a development kit in stage 134 can be optional or even absent.

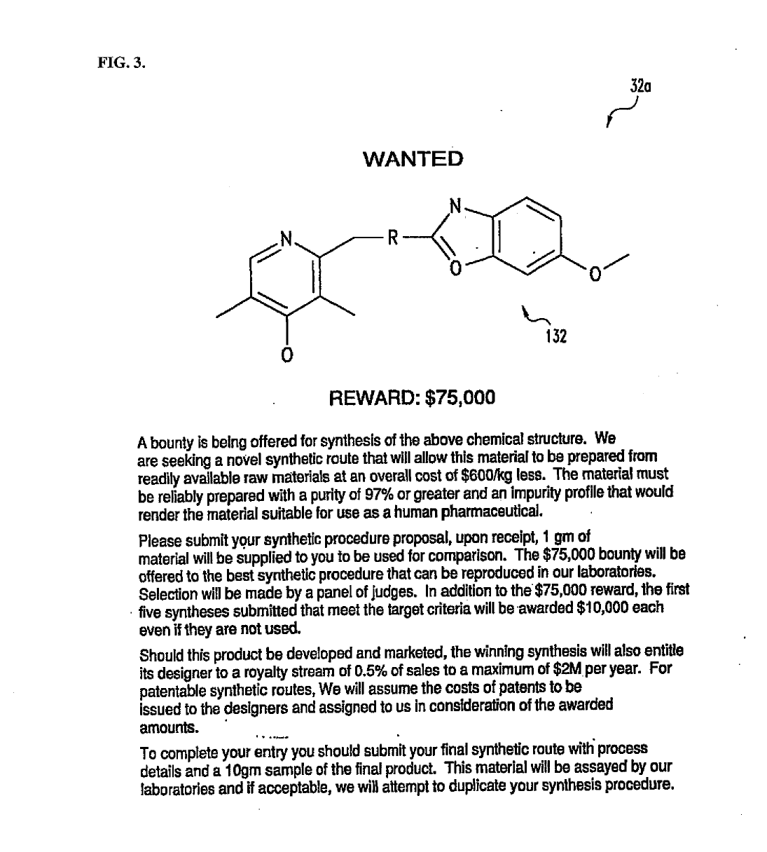

One particular description example, description 32a, is further illustrated in FIG. 3. For description 32a, the corresponding technical task relates to synthesis of a schematically depicted chemical structure 132 in a manner acceptable for use as a human pharmaceutical with criteria including an overall cost goal and purity level as set forth in the first paragraph. The reward included in description 32a has a cash component of $75,000 and a royalty stream component contingent upon use of the synthesis process developed. The royalty is capped at a maximum of $2,000,000 per year.

Referring also to FIG. 2B, routine 120 continues with evaluation subroutine 140. Evaluation subroutine 140 starts with conditional 142 that tests whether results have been provided by a participating party in response to the corresponding description 32 of stage 124. For a pharmaceutical development application, these results can include data provided by designated laboratory procedures and/or equipment. More specifically, as depicted in FIG. 2B, process evaluation subroutine 140 is directed to evaluating performance of the technical task of description 32a. For description 32a, spectroscopic analysis of the output produced by the developed chemical synthesis procedure is to be submitted as part of the evaluation. Conditional 144 accordingly tests whether the spectral data indicates an acceptable process. If the spectrum is not acceptable, the unacceptable status is reported to the submitting participant in stage 154 and subroutine 140 loops back to conditional 142.

If the spectral results are acceptable, then subroutine 140 proceeds to stage 146 to request a sample of a corresponding chemical compound produced by the participant as would be appropriate for the case of the new synthesis route development. For other types of technical tasks, a sample could be provided at the same time as spectral data is provided in stage 142, or may not be included as part of the evaluation criteria at all. If a sample is submitted in response to stage 146, its acceptability is then evaluated in accordance with conditional 148 using some or all of the associated chemical analysis equipment 50 as needed. In one embodiment relating to the description 32a of FIG. 3, spectral analysis is conducted with this equipment to evaluate the sample, and/or one or more assays are performed. If the sample is unacceptable as tested by conditional 148, this negative evaluation is reported in stage 154 and subroutine 140 loops back to conditional 142. If the sample is acceptable, in stage 150 an attempt is made to replicate the process, as applicable.

Conditional 152 tests whether the replication is acceptable. If the replication is unacceptable, subroutine 140 reports to the participant in stage 154 and returns to conditional 142. If the submitted process is acceptably validated by the replication, subroutine 140 is exited and the reward is provided in stage 160. Next, in stage 162, the description is altered as appropriate to the circumstances. For example, it may be altered to indicate that the bounty has been claimed or otherwise modify the conditions under which participation is to continue.

In an alternative embodiment, the reward may not be provided in stage 160 until an appropriate length of time passes, and/or until all known participants have been evaluated. In other cases, the description may unconditionally provide the reward to the first party to meet the acceptance criteria, while in others it may be the best process among several participants that exceed predefined, minimum requirements. Indeed, in still other embodiments, one or more participants that meet the minimum acceptance criteria can be rewarded. In fact, referring to the description of FIG. 3, the first five synthesis procedures that meet the target criteria are each provided a cash award of ten thousand dollars ($10,000), even if they are not used. It should be understood that routine 120 can be executed with system 20 for any of a number of different bounty descriptions 32 at the same time.

For different types of technical tasks bountied by routine 120, evaluation routine 140 can be suitably adjusted. For example, a given task may not produce a spectrum and/or sample—instead the evaluation is based on other quantitative and/or qualitative data as appropriate for the given task type. Furthermore, besides various pharmaceutical development applications, technical tasks directed to other developments/applications can be performed in accordance with the present invention. By way of nonlimiting example, technical tasks can be bountied for providing/developing: (a) an electrical circuit designed to a designated specification; (b) an optical lens designed to a designated specification; (c) a polymer having specified properties; (d) a software program having specified performance parameters; (e) a superconductor with specified properties; and/or (f) such other material, procedure, product, system, or assembly as would occur to those skilled in the art.

All publications and patent applications cited in this specification are herein incorporated by reference as if each individual publication or patent application were specifically and individually indicated to be incorporated by reference. Further, any theory, mechanism of operation, proof, or findings stated herein is meant to further enhance understanding of the present invention, and is not intended to limit the present invention in any way to such theory, mechanism of operation, proof, or finding. While the invention has been illustrated and described in detail in the drawings and foregoing description, the same is to be considered as illustrative and not restrictive in character, it being understood that only preferred embodiments have been shown and described and that all equivalents, changes, and modifications that come within the spirit of the inventions as defined by the following claims are desired to be protected.

1.-35. (canceled)

36. A computer implemented method, comprising:
using at least one computer server, publishing a description of a technical task to a number of parties over a publicly accessible computer network, the technical task being directed to one or more of technical research, laboratory testing, product discovery, product development, or product manufacture, the description offering a reward contingent upon the performance of the technical task by any of the parties in accordance with a predefined requirement;
using an evaluation equipment, determining whether one of the parties performed the technical task in accordance with the predefined requirement; and
providing the reward to the one of the parties that has performed the technical task in accordance with the predefined requirement.

37. The method of claim 36, wherein the technical task includes providing at least one of the group consisting of:
a synthesis procedure for a specified drug chemical, a drug chemical, an assay for a specified drug chemical, a drug formulation, a library of different chemicals relating to drugs, a metabolite identification, a pharmacological screen to show activity of a drug, a surrogate marker for a disease state, and an animal model for a specified disease.

38. The method of claim 36, wherein the technical task relates to a drug chemical.

39. The method of claim 38, wherein the technical task includes establishing a procedure for synthesizing the drug chemical.

40. The method of claim 36, wherein the description is provided in the form of one or more web pages.

41. A computer-implemented method, comprising:
using at least one computer server, publishing a description including a reward offer for acceptable performance of a technical task involving a chemical compound in accordance with a predefined requirement;
communicating with each of a number of parties responding to the description;
providing an amount of the chemical compound to each of the number of parties;
using an evaluation equipment, evaluating performance of the technical task by one of the parties in accordance with the predefined requirement; and
rewarding the one of the parties, that has performed the technical task in accordance with the predefined requirement, in accordance with the reward offer.

42. The method of claim 41, wherein the chemical compound includes a drug chemical.

43. The method of claim 41, wherein the technical task includes providing at least one of: a synthesis procedure for the chemical compound, an assay for the chemical compound, a drug formulation including the chemical compound, and a pharmacological screen to show activity of the chemical compound as a drug.

44. The method of claim 41, wherein said providing includes:
posting the offer over a computer network including the interne; and
presenting the offer in the form of one or more web pages publicly accessible on the world wide web.

45. A system, comprising:
a computer network;
an input device;
a computer server coupled to said network and said input device, said computer server including logic to present a publicly accessible description over said computer network including a reward offer for acceptable performance of a technical task associated with a designated chemical compound in accordance with a predefined requirement;
chemical analysis equipment to evaluate a compound sample submitted by one or more parties in accordance with the predefined requirement in response to the reward offer; and
wherein said computer server is responsive to input from said input device to alter the description after the acceptable performance of the technical task is determined through an evaluation performed with said chemical analysis equipment;
wherein the one of the parties that has acceptably performed the technical task in accordance with the predefined requirement is rewarded in accordance with the reward offer.

46. The system of claim 45, wherein said computer network includes the interne, said computer server is programmed to provide the description in the form of one or more web pages, and the one or more parties each correspond to a different interface device coupled to said computer network.

47. The system of claim 45, wherein said chemical analysis equipment includes a spectroscopic analyzer.

48. A system comprising:
a computer network communicatively coupling a number of interface devices together;
at least one computer server coupled the computer network configured to publish a description accessible through any of said interface devices over said computer network, the description including a reward offer for performance of a technical task in accordance with one or more specified criteria;
an evaluation equipment configured to evaluate the performance of the technical task, in accordance with the one or more specified criteria, by one or more of the parties in response to the reward offer; and
wherein one of the parties that has acceptably performed the technical task in accordance with one or more specified criteria, as determined by the analysis equipment, is rewarded in accordance with the reward offer.
